(19) United States
(12) Patent Application Publication
(10) Pub. No.: US 2026/0172194 A1
(43) Pub. Date: Jun. 18, 2026

(54) TECHNIQUES FOR LINKING MODULATION FOR MULTI-TRANSMISSION RECEPTION POINT (TRP) PHYSICAL DOWNLINK CONTROL CHANNEL (PDCCH)

(71) Applicant: QUALCOMM Incorporated, San Diego, CA (US)

(72) Inventors: Mahmoud TAHERZADEH BOROUJENI, San Diego, CA (US); Pinar SEN, San Diego, CA (US); Wei YANG, San Diego, CA (US); Tao LUO, San Diego, CA (US); Jing JIANG, San Diego, CA (US)

(21) Appl. No.: 18/981,178

(22) Filed: Dec. 13, 2024

(51) Int. Cl. H04L 5/00; H04L 27/00; H04W 72/232

(52) U.S. Cl. CPC H04L 5/0053; H04L 5/0035; H04L 27/0008; H04W 72/232

(57) ABSTRACT

Methods, systems, and devices for wireless communications are described. In some examples, a wireless communication device (such as a network entity) may output a downlink control channel message using at least a first resource element (RE) of a first control resource set (CORESET) and using at least a second RE of a second CORESET. The first CORESET and the second CORESET may be linked and may be associated with different transmission configuration indicator (TCI) states. Additionally, each of the first RE and the second RE may be associated with a same payload of the downlink control channel message, and modulation of a first set of symbols mapped to the first RE may be linked to modulation of a second set of symbols mapped to the second RE based on the first CORESET and the second CORESET being linked.

### TECHNICAL FIELD

The following relates to wireless communications, including techniques for linking modulation for multi-transmission reception point (TRP) physical downlink control channel (PDCCH).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include outputting a control message indicative of a linkage between a first control resource set (CORESET) and a second CORESET, where the first CORESET is associated with a first transmission configuration indicator (TCI) state, and where the second CORESET is associated with a second TCI state different from the first TCI state and outputting a first resource element (RE) via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

A network entity for wireless communications is described. The network entity may include one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the network entity to output a control message indicative of a linkage between a first CORESET and a second CORESET, where the first CORESET is associated with a first TCI state, and where the second CORESET is associated with a second TCI state different from the first TCI state and output a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

Another network entity for wireless communications is described. The network entity may include means for outputting a control message indicative of a linkage between a first CORESET and a second CORESET, where the first CORESET is associated with a first TCI state, and where the second CORESET is associated with a second TCI state different from the first TCI state and means for outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

A non-transitory computer-readable medium storing code for wireless communications at a network entity is described. The code may include instructions executable by at least one processor (e.g., directly, indirectly, after pre-processing, without pre-processing) to output a control message indicative of a linkage between a first CORESET and a second CORESET, where the first CORESET is associated with a first TCI state, and where the second CORESET is associated with a second TCI state different from the first TCI state and output a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

Some examples of the method, network entities, and non-transitory computer-readable medium described herein may further include operations, features, means, or instructions for rotating a first set of constellation points associated with a first modulation scheme to generate a first set of rotated constellation points and projecting the first set of rotated constellation points onto a first axis to generate a first set of projected constellation points and onto a second axis to generate a second set of projected constellation points, where modulation of the first set of symbols may be linked to modulation of the second set of symbols based on the projection.

Some examples of the method, network entities, and non-transitory computer-readable medium described herein may further include operations, features, means, or instructions for mapping a set of bits associated with the payload to each of the first set of projected constellation points and the second set of projected constellation points, where the first set of symbols may be based on the set of bits being mapped to the first set of projected constellation points, and where the second set of symbols may be based on the set of bits being mapped to the second set of projected constellation points.

In some examples of the method, network entities, and non-transitory computer-readable medium described herein, each of the first set of projected constellation points and the second set of projected constellation points may be associated with a respective one-dimensional constellation.

Some examples of the method, network entities, and non-transitory computer-readable medium described herein may further include operations, features, means, or instructions for rotating a second set of constellation points associated with a second modulation scheme to generate a second set of rotated constellation points and projecting the second set of rotated constellation points onto a third axis to generate a third set of projected constellation points and onto a fourth axis to generate a fourth set of projected constellation points, where the first set of symbols may be based on the first set of projected constellation points and the third set of projected constellation points, and where the second set of symbols may be based on the second set of constellation points and the fourth set of projected constellation points.

Some examples of the method, network entities, and non-transitory computer-readable medium described herein may further include operations, features, means, or instructions for generating a first two-dimensional constellation based on the first set of projected constellation points and the third set of projected constellation points, generating a second two-dimensional constellation based on the second set of constellation points and the fourth set of projected constellation points, and mapping a set of bits associated with the downlink control channel message to each of a third set of constellation points associated with the first two-dimensional constellation and a fourth set of constellation points associated with the second two-dimensional constellation, where the first set of symbols may be based on the set of bits being mapped to the third set of constellation points, and where the second set of symbols may be based on the set of bits being mapped to the fourth set of projected constellation points.

In some examples of the method, network entities, and non-transitory computer-readable medium described herein, the first set of projected constellation points correspond to respective in-phase components of the third set of constellation points, the third set of projected constellation points correspond to respective quadrature-phase components of the third set of constellation points, the second set of constellation points correspond to respective in-phase components of the fourth set of constellation points, and the fourth set of constellation points correspond to respective quadrature-phase components of the fourth set of constellation points.

In some examples of the method, network entities, and non-transitory computer-readable medium described herein, the first set of symbols may be equivalent to the second set of symbols based on the projection.

In some examples of the method, network entities, and non-transitory computer-readable medium described herein, the first modulation scheme may be a quadrature phase shift keying (QPSK) modulation scheme or a quadrature amplitude modulation (QAM).

In some examples of the method, network entities, and non-transitory computer-readable medium described herein, the first CORESET and the second CORESET may be associated with a joint multi-beam search space set and the control message may be indicative of the joint multi-beam search space set.

In some examples of the method, network entities, and non-transitory computer-readable medium described herein, the downlink control channel message may be associated with cross-beam aggregation based on a set of paired control channel elements associated with the joint multi-beam search space set and each paired control element from the set of paired control channel elements includes a first control channel element from a first set of control channel elements associated with the first CORESET and a second control channel element from a second set of control channel elements associated with the second CORESET.

In some examples of the method, network entities, and non-transitory computer-readable medium described herein, the first RE may be output via the first set of control channel elements associated with the first CORESET and the second RE may be output via the second set of control channel elements associated with the second CORESET.

In some examples of the method, network entities, and non-transitory computer-readable medium described herein, a cross-beam aggregation level associated with the downlink control channel message may be based on a quantity of paired control channel elements in the set of paired control channel elements.

In some examples of the method, network entities, and non-transitory computer-readable medium described herein, a value corresponding to the cross-beam aggregation level may be twice the quantity of the paired control channel elements.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for linking modulation for multi-transmission reception point (TRP) physical downlink control channel (PDCCH) in accordance with one or more aspects of the present disclosure.

FIG. 2 shows an example of a wireless communications system that supports techniques for linking modulation for multi-TRP PDCCH in accordance with one or more aspects of the present disclosure.

FIG. 3 shows an example of a control resource set (CORESET) diagram that supports techniques for linking modulation for multi-TRP PDCCH in accordance with one or more aspects of the present disclosure.

FIG. 4 shows an example of a modulation diagram that supports techniques for linking modulation for multi-TRP PDCCH in accordance with one or more aspects of the present disclosure.

FIG. 5 shows an example of a process flow that supports techniques for linking modulation for multi-TRP PDCCH in accordance with one or more aspects of the present disclosure.

FIGS. 6 and 7 show block diagrams of devices that support techniques for linking modulation for multi-TRP PDCCH in accordance with one or more aspects of the present disclosure.

FIG. 8 shows a block diagram of a communications manager that supports techniques for linking modulation for multi-TRP PDCCH in accordance with one or more aspects of the present disclosure.

FIG. 9 shows a diagram of a system including a device that supports techniques for linking modulation for multi-TRP PDCCH in accordance with one or more aspects of the present disclosure.

FIG. 10 shows a flowchart illustrating methods that support techniques for linking modulation for multi-TRP PDCCH in accordance with one or more aspects of the present disclosure.

### DETAILED DESCRIPTION

Some wireless communications systems may support multi-transmission reception point (TRP) physical downlink control channel (PDCCH) transmissions in which a network entity may transmit PDCCH repetitions on multiple (e.g., two) linked search space (SS) sets using multiple (e.g., two) different beams (e.g., on corresponding control resource sets (CORESETs) associated with different transmission configuration indicator (TCI) states). The network entity may transmit a first PDCCH repetition via a first SS set (e.g., associated with a first CORESET and a first TCI state) and a second PDCCH repetition via a second SS set (e.g., associated with a second CORESET and a second TCI state different than the first TCI state). In such cases, the first SS set and the second SS set may be linked (e.g., respective PDCCH candidates associated with the SS sets may be explicitly linked) and a user equipment (UE) receiving the PDCCH repetitions may be aware of the linkage prior to decoding the PDCCH transmission. Additionally, the first PDCCH repetition and the second PDCCH repetition may include a same downlink control information (DCI) payload, may be associated with a same aggregation level (AL), and/or may include a same set of coded bits. However, further improvements to spatial diversity for multi-TRP PDCCH transmissions may be desired.

The techniques described herein may support rotated quadrature phase shift keying (QPSK) (e.g., or twisted binary phase shift keying (BPSK)) for multi-TRP PDCCH. For example, a network entity may transmit, to a UE, an indication of a linkage between a first CORESET and a second CORESET, where the first CORESET is associated with a first TCI state and the second CORESET is associated with a second TCI state, different than the first TCI state (e.g., the network entity may configure the UE for multi-TRP PDCCH communications). Additionally, the network entity may perform rotated modulation (e.g., rotated QPSK modulation) in which the network entity rotates a set of constellation points associated with, for example, a QPSK modulation scheme to generate a set of rotated constellation points. The network entity may project the set of rotated constellation points onto a first axis to generate a first set of projected constellation points. Similarly, the network entity may project the set of rotated constellation points onto a second axis (e.g., perpendicular to the first axis) to generate a second set of projected constellation points. The network entity may further map a set of DCI bits (e.g., control information bits) to each of the first set of projected constellation points and the second set of projected constellation points. As such, a first set of symbols (e.g., a first symbol) may be based on the set of DCI bits being mapped to the first set of projected constellation points and a second set of symbols (e.g., a second symbol) may be based on the set of DCI bits being mapped to the second set of projected constellation points. Thus, the network entity may allocate the first set of symbols to a first RE and the second set of symbols to a second resource element (RE) and may transmit both the first RE (e.g., via the first CORESET) and the second RE (e.g., via the second CORESET) to the UE.

Aspects of the disclosure are initially described in the context of wireless communications systems. Aspects of the disclosure are then described in the context of constellation diagrams and a process flow. Aspects of the disclosure are further illustrated by and described with reference to apparatus diagrams, system diagrams, and flowcharts that relate to techniques for linking modulation for multi-TRP PDCCH.

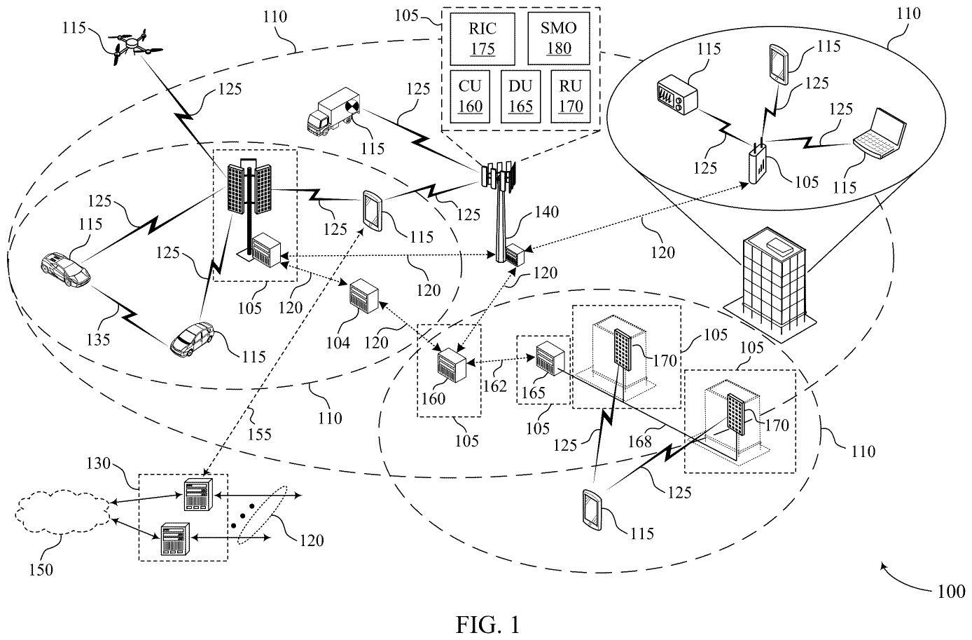

FIG. 1 shows an example of a wireless communications system 100 that supports techniques for linking modulation for multi-TRP PDCCH in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for linking modulation for multi-TRP PDCCH as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, an MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2-D) communication link, such as a D2-D communication link 135 (e.g., in accordance with a peer-to-peer (P2P), D2-D, or sidelink protocol). In some examples, one or more UEs 115 of a group that are performing D2-D communications may be within the coverage area 110 of a network entity 105 (e.g., a base station 140, an RU 170), which may support aspects of such D2-D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2-D communications may support a one-to-many (1:M) system in which each UE 115 transmits to one or more of the UEs 115 in the group. In some examples, a network entity 105 may facilitate the scheduling of resources for D2-D communications. In some other examples, D2-D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2-D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications systems 100 may support two-symbol unitary rotation (e.g., applied on symbols from different CCEs that are a threshold distance apart in frequency). In such cases, wireless devices of the wireless communications system 100 may use two-symbol unitary rotated to exploit frequency diversity for performance enhancements of PDCCH. In some cases, the wireless devices may support two-symbol unitary rotation instead of two-port diversity schemes (e.g., Alamouti) due to two-symbol unitary rotation using a single antenna port (e.g., rather than multiple antenna ports). Additionally, or alternatively, the wireless devices may support BPSK (e.g., or a two-symbol unitary rotation version of BPSK) for higher ALs (e.g., ALs exceeding a threshold level) of PDCCH (e.g., instead of QPSK or QPSK repetition) to support increased resilience against channel estimation noise (e.g., phase noise). Additionally, or alternatively, the wireless devices may support mixed aggregation across monitoring occasions for cross-beam aggregation, which may result in better performance than PDCCH repetition for small or medium ALs (e.g., for ALs less than the threshold level, similar to benefits of transport block over multiple slot (TBoMS) transmissions). In some examples, such as millimeter wave, a channel may be less frequency selective, however, in multi-TRP PDCCH, independently fading channels may be present.

In some cases, wireless devices of the wireless communications system 100 may support rotated QPSK modulation (e.g., or twisted BPSK modulation) for multi-TRP PDCCH. For example, a network entity 105 may transmit, to a UE 115, an indication of a linkage between a first CORESET and a second CORESET, where the first CORESET is associated with a first TCI state and the second CORESET is associated with a second TCI state, different than the first TCI state (e.g., the network entity 105 may configure the UE 115 for multi-TRP PDCCH communications).

Additionally, the network entity 105 may perform rotated modulation (e.g., QPSK modulation) in which the network entity 105 rotates a set of constellation points associated with, for example, a QPSK modulation scheme to generate a set of rotated constellation points. The network entity 105 may project the set of rotated constellation points onto a first axis to generate a first set of projected constellation points. Similarly, the network entity 105 may project the set of rotated constellation points onto a second axis (e.g., perpendicular to the first axis) to generate a second set of projected constellation points. The network entity 105 may further map a set of DCI bits (e.g., control information bits) to each of the first set of projected constellation points and the second set of projected constellation points. As such, a first set of symbols (e.g., a first symbol) may be based on the set of DCI bits being mapped to the first set of projected constellation points and a second set of symbols (e.g., a second symbol) may be based on the set of DCI bits being mapped to the second set of projected constellation points. Thus, the network entity 105 may allocate the first set of symbols to a first RE and the second set of symbols to a second RE and may transmit both the first RE (e.g., via the first CORESET) and the second RE (e.g., via the second CORESET) to the UE 115.

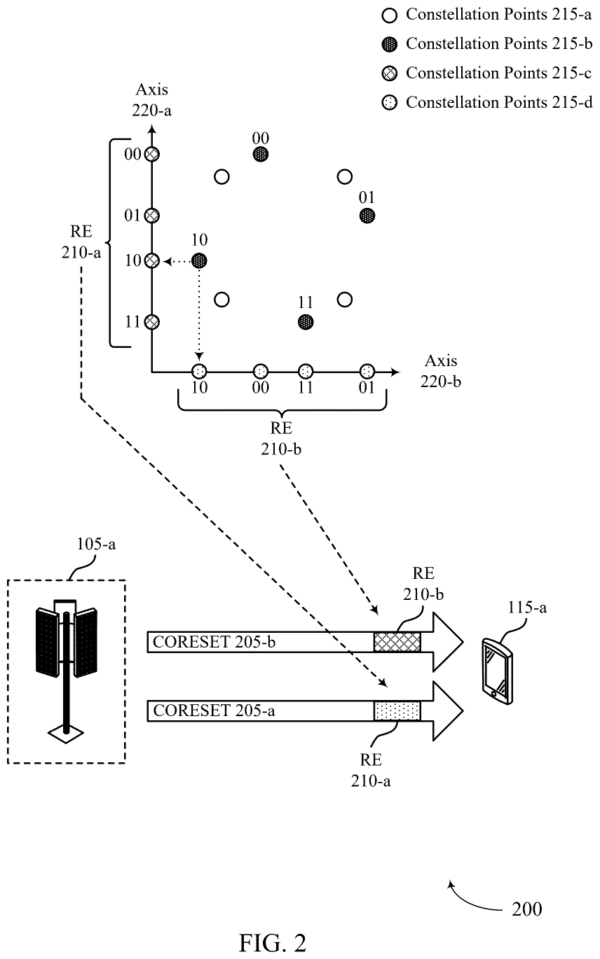

FIG. 2 shows an example of a wireless communications system 200 that supports techniques for linking modulation for multi-TRP PDCCH in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

Some wireless communications systems, such as the wireless communications system 200, may support multi-TRP PDCCH transmissions in which a network entity 105, such as the network entity 105-a, may transmit PDCCH repetitions on two link SS sets using two different beams (e.g., on corresponding CORESETs 205) associated with different TCI states). In other words, the network entity 105-a may transmit a first PDCCH repetition (e.g., a first PDCCH candidate) via a first SS set (e.g., associated with a first CORESET 205 and a first TCI state) and a second PDCCH repetition via a second SS set (e.g., associated with a second CORESET 205 and a second TCI state, different than the first TCI state). In such cases, the first SS set and the second SS set may be linked (e.g., respective PDCCH candidates associated with the SS sets may be explicitly linked) and a UE 115, such as the UE 115-a, receiving the PDCCH repetitions may be aware of the linkage prior to decoding. Additionally, the first PDCCH repetition and the second PDCCH repetition may include a same DCI payload, may be associated with a same AL, and may include a same set of coded bits. In some examples, configuration of the SS sets (e.g., the first SS set and the second SS set) may be associated with one or more restrictions to facilitate the linkage between the first SS set and the second SS set. For example, the network entity 105-a and the UE 115-a may support a one-to-one mapping between monitoring occasions (MOs) and PDCCH candidates). Additionally, or alternatively, the first PDCCH repetition and the second PDCCH repetition may be intra-slot PDCCH repetitions (e.g., in a same slot, rather than inter-slot PDCCH repetitions).

In such cases, the network entity 105-a and the UE 115-a may support one or more levels of linkage. For example, a first level of linkage (e.g., Level 1) may be associated (e.g., based on) with two SS sets, such as the first SS set and the second SS set, being linked via RRC configuration (e.g., in RRC). In such cases, the network entity 105-a and the UE 115-a may support the first level of linkage for UE-specific search spaces (USS) sets, Type 3 common search spaces (CSS) sets, or both (e.g., and not for other CSS sets such as Type 0 CSS sets, Type OA CSS sets, Type 1 CSS sets, and Type 2 CSS sets; and not for recoverSearchSpaceId). Additionally, or alternatively, SS sets linked according to the first level of linkage (e.g., the first SS set and the second SS set) may be associated with a same periodicity, a same slot offset, a same duration, a same SS set type, same DCI formats to monitor, or any combination thereof.

A second level of linkage (e.g., Level 2) may be associated with an n^{th} MO of one SS set, such as the first SS set, being linked to an n^{th} MO of a second SS set, such as the second SS set. In other words, the first SS set and the second SS set may be linked based on a linkage between MOs (e.g., across SS sets). In such cases, the first SS set and the second SS set may be associated with (e.g., configured with) a same quantity of MOs within a slot. A third level of linkage (e.g., Level 3) may be associated with two PDCCH candidates with a same AL and a same candidate index being linked. In other words, the first SS set and the second SS set may be linked based on a linkage between PDCCH candidates (e.g., across SS sets). In such cases, the first SS set and the second SS set may be associated with (e.g., configured with) a same quantity of PDCCH candidates for each AL.

In some examples, as described herein, the network entity 105-a, the UE 115-a, or both, may support two-symbol unitary rotation for PDCCH enhancements in multi-TRP PDCCH (e.g., or PDCCH transmission with multiple TCI states). That is, techniques described herein may support rotated QPSK modulation (e.g., or twisted BPSK modulation) for multi-TRP PDCCH (e.g., rather than PDCCH repetition on multiple beams). For example, in some cases, a network entity 105, such as the network entity 105-a, may transmit, to a UE 115, such as the UE 115-a, an indication of a linkage between a CORESET 205-a (e.g., a first SS set) and a CORESET 205-b (e.g., a second SS set). In such cases, the CORESET 205-a may be associated with a first TCI state and the CORESET 205-b may be associated with a second TCI state, where the first TCI state is different than the second TCI state (e.g., the network entity 105-a may configure the UE 115-a for multi-TRP PDCCH).

Additionally, the network entity 105-a may perform rotated QPSK modulation on two REs 210, such as an RE 210-a and an RE 210-b, (e.g., or twisted BPSK, rather than QPSK repetition) in which the network entity 105-a may rotate a set of constellation points 215-a associated with a QPSK modulation scheme (e.g., a first modulation scheme) to generate a set of constellation points 215-b (e.g., a rotated set of constellation points 215; 00, 10, 01, and 11). Additionally, the network entity 105-a may project the set of constellation points 215-a onto an axis 220-a (e.g., S1) to generate a set of constellation points 215-c (e.g., a first set of projected constellation points 215) and onto an axis 220-b (e.g., S2, perpendicular to S1) to generate a set of constellation points 215-d (e.g., a second set of projected constellation points 215). In such cases, each of the set of constellation points 215-c and the set of constellation points 215-d may represent a 1-dimensional (1-D) constellation.

In some examples, a “rotation” may refer to a constellation diagram of a digital signal for some data that is rotated, such that an overall energy associated with the digital signal remains the same (e.g., or relatively close to the same, within some threshold). For example, and in accordance with examples as described herein, the wireless communications system 200 may implement rotations of constellations to support increased frequency diversity for signaling between the UE 115-a and the network entity 105-a. In some examples, to implement a rotation for a signal, such as for a control message, the network entity 105-a (e.g., or another wireless device) may couple frequency tones associated with the signal with a coupling matrix, which may introduce frequency diversity (e.g., for PDCCH). A frequency tone may refer to a complex valued symbol generated by a transmitter to represent one or more bits of the control message. For example, a coupling matrix may be applied as shown in Equation 1 below.

$$[ \begin{matrix}{\tilde{x}}_{1} \\ {\tilde{x}}_{2}\end{matrix} ] = R [ \begin{matrix}{x}_{1} \\ {x}_{2}\end{matrix} ] \qquad ( 1 )$$

In Equation 1, x₁ and x₂ may refer to frequency tones associated with the control message to be transmitted and may correspond (e.g., be assigned) to far-apart resource elements (e.g., in time, with some threshold separation duration), 1 and 2 may refer to the frequency tones after the rotation is applied, and R may refer to the coupling matrix, which may correspond to the rotation (e.g., for a Hadamard product, for discrete Fourier transform) applied to the frequency tones x₁ and x₂.

In some examples, the rotation may include a uniform transformation over (e.g., at least) two resource elements (e.g., as in 2×2 MIMO). For example, the uniform transformation may result in a rotation of in-phase (e.g., I) and quadrature (e.g., Q) components of the signal, which may correspond to a two-symbol unitary rotation, and the uniform transformation may be given by Equation 2 below.

$$[ \begin{matrix}{x}_{1}^{′} \\ {x}_{2}^{′}\end{matrix} ] = [ \begin{matrix}cos ( θ ) & - sin ( θ ) \\ sin ( θ ) & cos ( θ )\end{matrix} ] [ \begin{matrix}{x}_{1} \\ {x}_{2}\end{matrix} ] \qquad ( 2 )$$

In Equation 2, x₁ and x₂ may correspond to frequency tones without the rotation applied for a first resource element and a second resource element, θ may correspond to the angle of rotation, and x′₁ and x′₂ may correspond to the frequency rotated tones to be transmitted at the first resource element and the second resource element. In some cases, each of the in-phase and quadrature components (e.g., before the rotation is applied) for a tone transmitted at a resource element k (e.g., k=1,2) may be described as shown in Equation 3 below.

$${x}_{k} = {I}_{k} + j {Q}_{k} \qquad ( 3 )$$

In some examples, after applying the rotation, the rotated in-phase and quadrature components of a frequency tone for each resource element may be based on the original (e.g., pre-rotation) values for the in-phase components for both frequency tones and corresponding resource elements. For example, for the first resource element after the rotation to a first frequency tone, the in-phase component (I′₁) and the quadrature component (Q′₁) may be described by Equations 4.1 and 4.2 below.

$${x}_{1}^{′} = {x}_{1} cos θ - {x}_{2} sin ( θ ) \to {I}_{1}^{′} = {I}_{1} cos ( θ ) - {I}_{2} sin ( θ ) \qquad ( 4.1 )$$

$$and {Q}_{1}^{′} = {Q}_{1} cos ( θ ) - {Q}_{2} sin ( θ ) \qquad ( 4.2 )$$

Additionally, for the second resource element after applying the rotation to a second frequency tone, the in-phase component (I′₂) and the quadrature component (Q′₂) may be described by Equations 5.1 and 5.2 below.

$${x}_{2}^{′} = {x}_{1} sin θ + {x}_{2} cos ( θ ) \to {I}_{2}^{′} = {I}_{1} sin ( θ ) + {I}_{2} cos ( θ ) \qquad ( 5.1 )$$

$$and {Q}_{2}^{′} = {Q}_{1} sin ( θ ) + {Q}_{2} cos ( θ ) \qquad ( 5.2 )$$

As such, the channel (e.g., D·R=H) for transmission of the control message may be represented by Equation 6 below.

$$[ \begin{matrix}{h}_{1} & 0 \\ 0 & {h}_{2}\end{matrix} ] [ \begin{matrix}cos ( θ ) & - sin ( θ ) \\ sin ( θ ) & cos ( θ )\end{matrix} ] = [ \begin{matrix}{h}_{1} cos ( θ ) & - {h}_{1} sin ( θ ) \\ {h}_{2} sin ( θ ) & {h}_{2} cos ( θ )\end{matrix} ] \qquad ( 6 )$$

The network entity 105-a may further map a set of DCI bits (e.g., control information bits) associated with a payload of a PDCCH message to each of the set of constellation points 215-c and the set of constellation points 215-d. As such, a first set of symbols (e.g., a first symbol) may be based on the set of DCI bits being mapped to the set of constellation points 215-c and a second set of symbols (e.g., a second symbol) may be based on the set of DCI bits being mapped to the set of constellation points 215-d. In other words, the first set of symbols may correspond to the second set of symbols based on the set of DCI bits being mapped to the set of constellation points 215-c and to the set of constellation points 215-d. Thus, the network entity 105-a may allocate the first set of symbols to an RE 210-a and the second set of symbols to an RE 210-b and may transmit, to the UE 115-a, the RE 210-a (e.g., the first set of symbols) via the CORESET 205-a (e.g., associated with the first TCI state) and the RE 210-b (e.g., the second set of symbols) via the CORESET 205-b (e.g., associated with the second TCI state). In other words, the network entity 105-a may transmit both real and imaginary parts of the constellation points 215-b (e.g., of a rotated QPSK) on two REs (e.g., the RE 210-a and the RE 210-b) with two different TCI states. The UE 115-a may obtain the information transmitted via the signal by decoding the rotated signals carried on the RE 210-a and the RE 210-b.

Though described in the context of a QPSK modulation scheme, this is not to be regarded as a limitation of the present disclosure. In this regard, the QPSK modulation scheme is merely an exemplary embodiment of a modulation scheme, such that other modulation schemes may be considered regarding the techniques described herein including, but not limited to, quadrature amplitude modulation (QAM).

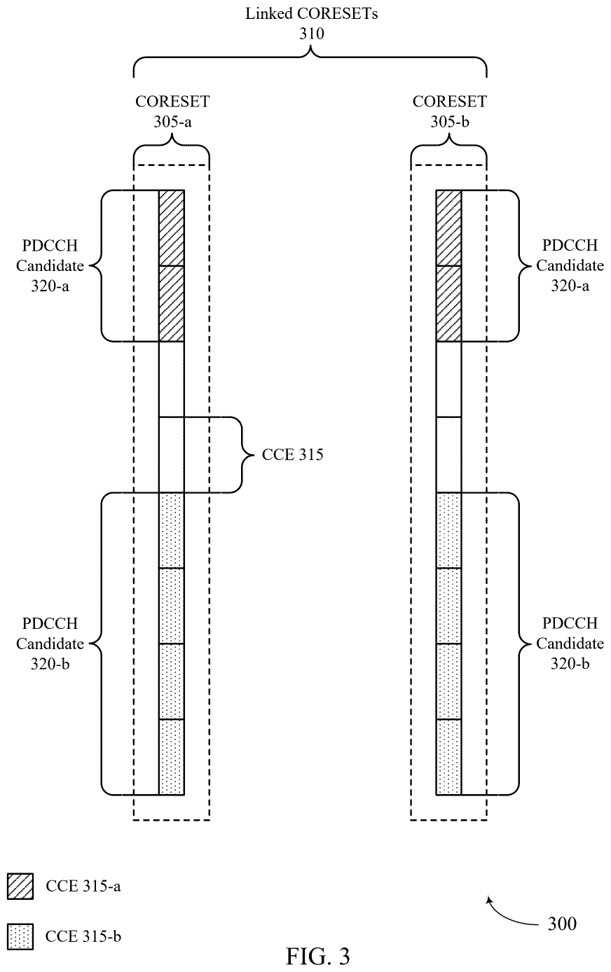

FIG. 3 shows an example of a CORESET diagram 300 (that supports techniques for linking modulation for multi-TRP PDCCH in accordance with one or more aspects of the present disclosure. In some cases, the CORESET diagram 300 may implement or be implemented by aspects of the wireless communications system 100, the wireless communications system 200, or both. For example, the CORESET diagram 300 may be implemented by one or more UEs 115, one or more network entities 105, or both, which may be examples of the corresponding devices as described herein.

In some cases, for transmission of multi-beam communications, multi-TRP PDCCH, or both, a joint multi-beam SS may be configured (e.g., by a network entity 105), where the joint multi-beam SS is associated with two or more CORESETs 305, such as a CORESET 305-a and a CORESET 305-b, associated with different TCI states. That is, the CORESET 305-a (e.g., associated with a first TCI state) and the CORESET 305-b (e.g., associated with a second TCI state, different than the first TCI state) may be linked CORESETs 310 and may be associated with a joint SS with cross-beam aggregation.

In such cases, PDCCH aggregation for the joint SS (e.g., multi-beam SS) may be achieved by using CCEs 315 from the two or more CORESETs 305. That is, for a PDCCH candidate 320 with an AL (e.g., aggregation) of 2 k and two CORESETs 305 (e.g., two linked CORESETs 310), as depicted in FIG. 3, the network entity 105 may use k pairs of CCEs 315 from the two CORESETs 305 in combination with linked modulation, as described with reference to FIG. 2. For example, for an AL of 4, the network entity 105-a may use a first set of CCEs 315-a (e.g., two CCEs 315-a) from the CORESET 305-a for (e.g., for transmission of) a first portion of a PDCCH candidate 320-a and may use a second set of CCEs 315-a (e.g., two CCEs 315-a) from the CORESET 305-b for (e.g., for transmission of) a second portion of the PDCCH candidate 320-a. In another example, for an AL of 8, the network entity 105-a may use a first set of CCEs 315-b (e.g., four CCEs 315-b) from the CORESET 305-a for (e.g., for transmission of) a first portion of a PDCCH candidate 320-b and may use a second set of CCEs 315-b (e.g., four CCEs 315-b) from the CORESET 305-b for (e.g., for transmission of) a second portion of the PDCCH candidate 320-b. In another words, the PDCCH candidate 320-b with the AL of 8 may be associated with two portions (e.g., two components) across two CORESETs 305 (e.g., the CORESET 305-a and the CORESET 305-b) associated with two TCI states (e.g., the first TCI state and the second TCI state).

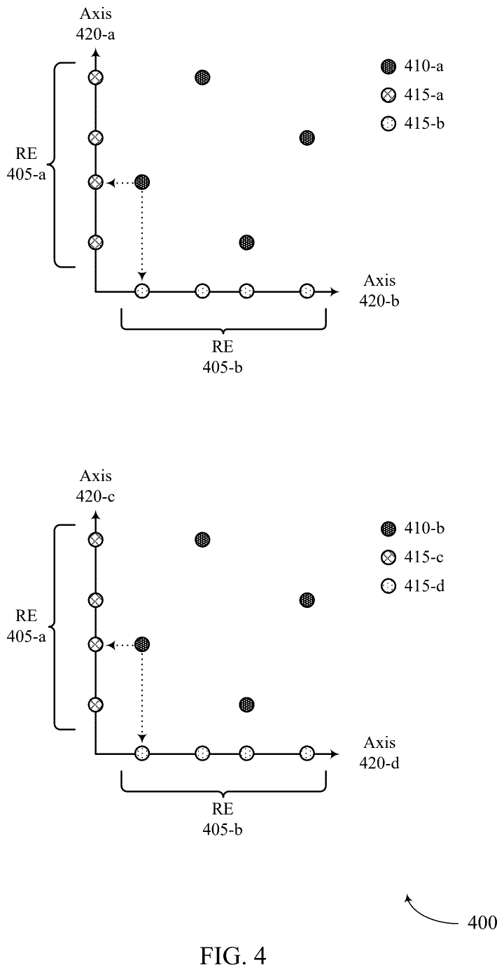

FIG. 4 shows an example of a modulation diagram 400 that supports techniques for linking modulation for multi-TRP PDCCH in accordance with one or more aspects of the present disclosure. In some cases, the modulation diagram 400 may implement or be implemented by aspects of the wireless communications system 100, the wireless communications system 200, the CORESET diagram 300, or any combination thereof. For example, the modulation diagram 400 may be implemented by one or more UEs 115, one or more network entities 105, or both, which may be examples of the corresponding devices as described herein.

In some examples, a network entity 105, a UE 115, or both, may support transmission of two-symbol rotations of two independent QPSKs on in-phase (e.g., I) and quadrature phase (e.g., Q) components of multiple (e.g., two) REs 405 from multiple (e.g., two) CCEs associated with different beams. That is, in some cases, the network entity 105 may rotate a first set of constellation points associated with a first QPSK modulation scheme (e.g., QPSK1) to generate a set of rotated constellation points 410-a and may rotate a second set of constellation points associated with a second QPSK modulation scheme (e.g., QPSK2) to generate a set of rotated constellation points 410-b.

Additionally, the network entity 105 may project the set of rotated constellation points 410-a onto an axis 420-a (e.g., I1) to generate a set of projected constellation points 415-a and onto an axis 420-b (e.g., I2) to generate a set of projected constellation points 415-b. Similarly, the network entity 105 may project the set of rotated constellation points 410-b onto an axis 420-c (e.g., Q1) to generate a set of projected constellation points 415-c and onto an axis 420-d (e.g., Q2) to generate a set of projected constellation points 415-d.

As such, the network entity 105 may generate a first two-dimensional (2-D) constellation based on the set of projected constellation points 415-a and the set of projected constellation points 415-c and may generate a second 2-D constellation based on the set of projected constellation points 415-b and the set of projected constellation points 415-d. That is, the first 2-D constellation may be associated with a first set of combined constellation points, where respective in-phase components of the first set of combined constellation points may be based on the set of projected constellation points 415-a and respective quadrature-phase components of the first set of combined constellation points may be based on the set of projected constellation points 415-c. In other words, for a combined constellation point from the first set of combined constellation points, an in-phase component of the combined constellation point may be based on a projected constellation point 415-a (e.g., from the set of projected constellation points 415-a) and a quadrature-phase component of the combined constellation point may be based on a projected constellation point 415-c (e.g., from the set of projected constellation points 415-c). Similarly, the second 2-D constellation may be associated with a second set of combined constellation points, where respective in-phase components of the second set of combined constellation points may be based on the set of projected constellation points 415-b and respective quadrature-phase components of the second set of combined constellation points may be based on the set of projected constellation points 415-d.

Thus, the network entity 105 may map a set of DCI bits (e.g., control information bits) associated with a payload of a PDCCH message to each of the first set of combined constellation points (e.g., of the first 2-D constellation) and the second set of combined constellation points (e.g., of the second 2-D constellation). As such, a first set of symbols (e.g., a first symbol) may be based on the set of DCI bits being mapped to the first set of combined constellation points and a second set of symbols (e.g., a second symbol) may be based on the set of DCI bits being mapped to the second set of combined constellation points. Further, the network entity 105-a may allocate the first set of symbols to the RE 405-a and the second set of symbols to the RE 405-b and may transmit, to the UE 115, the RE 405-a (e.g., the first set of symbols) via a first CCE associated with a first beam (e.g., associated with a first TCI state) and the 405-b (e.g., the second set of symbols) via a second CCE associated with a second beam (e.g., associated with a second TCI state), different than the first beam. In other words, the network entity 105 may transmit a first QPSK (e.g., associated with the first QPSK modulation scheme) via in-phase components of each set of combined constellation points (e.g., I1 and I2) and may transmit a second QPSK (e.g., associated with the second QPSK modulation scheme) via quadrature-phase components of each set of combined constellation points (e.g., Q1 and Q2).

Though described in the context of a QPSK modulation scheme, this is not to be regarded as a limitation of the present disclosure. In this regard, the QPSK modulation scheme is merely an exemplary embodiment of a modulation scheme, such that other modulation schemes may be considered with regards to the techniques described herein including, but not limited to, QAM.

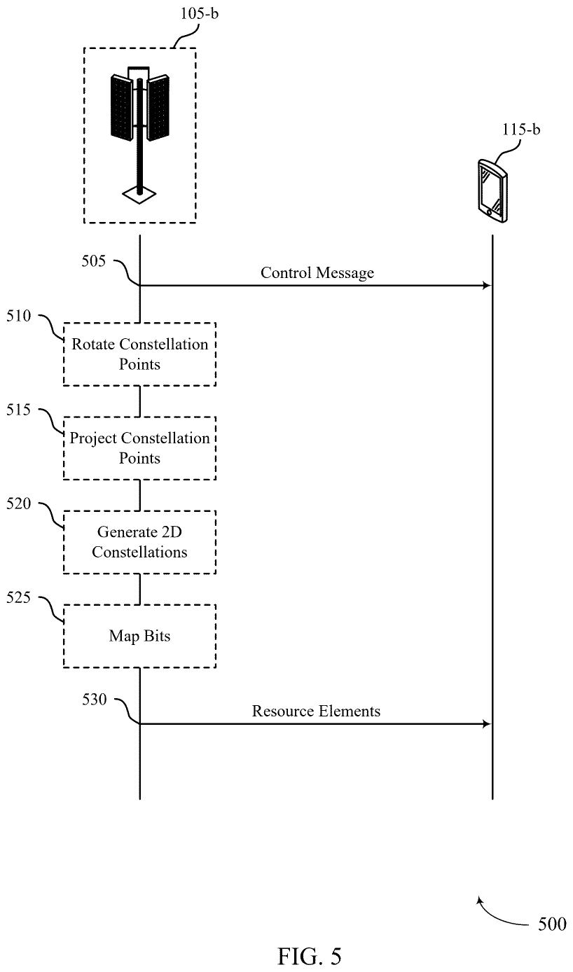

FIG. 5 shows an example of a process flow 500 that supports techniques for linking modulation for multi-TRP PDCCH in accordance with one or more aspects of the present disclosure. In some cases, the process flow 500 may implement or be implemented by aspects of the wireless communications system 100, the wireless communications system 200, the CORESET diagram 300, the modulation diagram 400, or any combination thereof. For example, the process flow 500 may include one or more UEs 115 (e.g., a UE 115-b) and one or more network entities 105 (e.g., a network entity 105-b), which may be examples of the corresponding devices as described herein. In the following description of the process flow 500, the operations between the UE 115-b and the network entity 105-b may be communicated in a different order than the example order shown, or the operations performed by the UE 115-b and the network entity 105-b may be performed in different orders or at different times. Some operations may also be omitted from the process flow 500, and other operations may be added to the process flow 500.

At 505, the network entity 105-b may transmit (e.g., output), to the UE 115-b), a control message indicative of a linkage between a first CORESET (e.g., first SS set) and a second CORSET (e.g., second SS set, where the first CORESET is associated with a first TCI state and the CORESET is associated with a second TCI state different from the first TCI state. In other words, the control message may indicate that the first CORESET is linked to the second CORESET. In some examples, the first CORESET and the second CORESET may additionally, or alternatively, be associated with a joint multi-beam SS set, such that the control message may be indicative of the joint multi-beam SS set.

In some cases, the network entity 105-b may support rotated QPSK modulation (e.g., or twisted BPSK modulation) for multi-TRP PDCCH. In such cases, at 510, the network entity 105-a may rotate a first set of constellation points associated with a first modulation scheme (e.g., QPSK, QAM, BPSK) to generate a first set of rotated constellation points and, at 515, may project the first set of rotated constellation points onto a first axis to generate a first set of projected constellation points and onto a second axis to generate a second set of projected constellation points. In such cases, each of the first set of projected constellation points and the second set of projected constellation points may be associated with a respective one-dimensional constellation. Additionally, at 525, the network entity 105-b may map a set of bits (e.g., DCI bits) associated with a payload of a downlink control channel message to each of the first set of projected constellation points and the second set of projected constellation points. In some cases, the downlink control channel message may be associated with cross-beam aggregation based on a set of paired CCEs associated with the joint multi-beam SS set, and each paired CCE from the set of paired CCE may include a first CCE from a first set of CCEs associated with the first CORESET and a second CCE from a second set of CCEs associated with the second CORESET. In some cases, a value corresponding to the cross-beam aggregation level may be twice the quantity of paired CCEs. As such, a first set of symbols may be based on the set of bits being mapped to the first set of projected constellation points and a second set of symbols may be based on the set of bits being mapped to the second set of projected constellation points. In other words, the first set of symbols may correspond to the second set of symbols based on the projection.

Additionally, or alternatively, the network entity 105-b may support transmission of two-symbol rotations of two independent QPSKs on in-phase (e.g., I) and quadrature phase (e.g., Q) components of two REs 405 from two CCEs associated with different beams. In such cases, at 510, the network entity 105-b may rotate the first set of constellation points associated with the first modulation scheme to generate the first set of rotated constellation points and may additionally rotate a second set of constellation points associated with a second modulation scheme (e.g., QPSK, QAM, BPSK) to generate a second set of rotated constellation points. Additionally, at 515, the network entity 105-b may project the first set of rotated constellation points onto the first axis to generate the first set of projected constellation points and onto the second axis to generate the second set of projected constellation points, and may additionally project the second set of rotated constellation points onto a third axis to generate a third set of projected constellation points and onto a fourth axis to generate a fourth set of projected constellation points. Thus, at 520, the network entity 105-b may generate a first 2-D constellation based on the first set of projected constellation points and the third set of projected constellation points and may generate a second two-dimensional constellation based on the second set of constellation points and the fourth set of projected constellation points. In other words, the first set of projected constellation points may correspond to respective in-phase components of the third set of constellation points, the third set of projected constellation points may correspond to respective quadrature-phase components of the third set of constellation points, the second set of constellation points may correspond to respective in-phase components of the fourth set of constellation points, and the fourth set of constellation points may correspond to respective quadrature-phase components of the fourth set of constellation points. Additionally, at 525, the network entity 105-b may map the set of bits associated with the downlink control channel message to each of a third set of constellation points associated with the first 2-D constellation (e.g., a first set of combined constellation points) and a fourth set of constellation points associated with the second 2-D constellation (e.g., a second set of combined constellation points), where the first set of symbols is based on the set of bits being mapped to the third set of constellation points and the second set of symbols is based on the set of bits being mapped to the fourth set of projected constellation points.

In either case, at 530, the network entity 105-b may transmit a first RE (e.g., the first set of symbols) via the first CORESET and a second RE (e.g., the second set of symbols) via the second CORESET, where modulation of the first set of symbols mapped to the first RE is linked to modulation of the second set of symbols mapped to the second RE (e.g., based on linkage between the first CORESET and the second CORESET, based on the projection, based on the mapping). In such cases, each of the first RE and the second RE may be associated with the same payload (e.g., of the downlink control channel message).

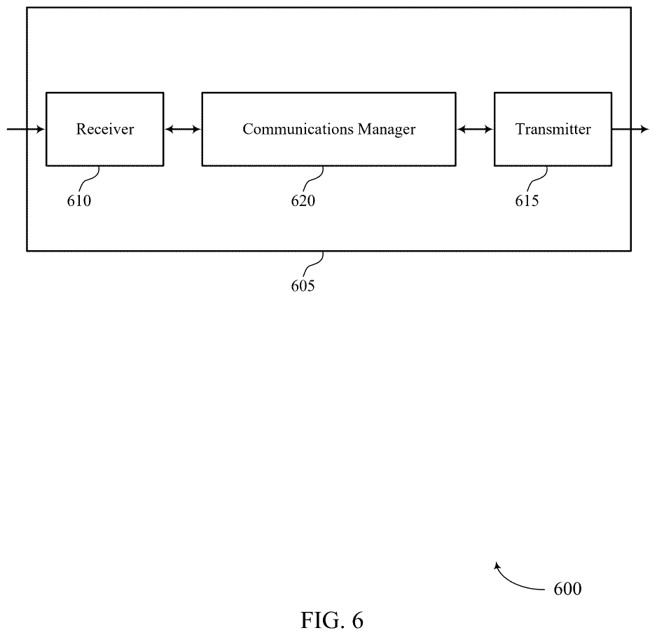

FIG. 6 shows a block diagram 600 of a device 605 that supports techniques for linking modulation for multi-TRP PDCCH in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of techniques for linking modulation for multi-TRP PDCCH as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application specific integrated circuit (ASIC), a graphics processing unit (GPU), a neural processing unit (NPU), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, a GPU, an NPU, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for outputting a control message indicative of a linkage between a first CORESET and a second CORESET, where the first CORESET is associated with a first TCI state, and where the second CORESET is associated with a second TCI state different from the first TCI state. The communications manager 620 is capable of, configured to, or operable to support a means for outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for linking modulation for multi-TRP PDCCH, which may result in reduced processing, reduced power consumption, and more efficient utilization of communication resources, among other advantages.

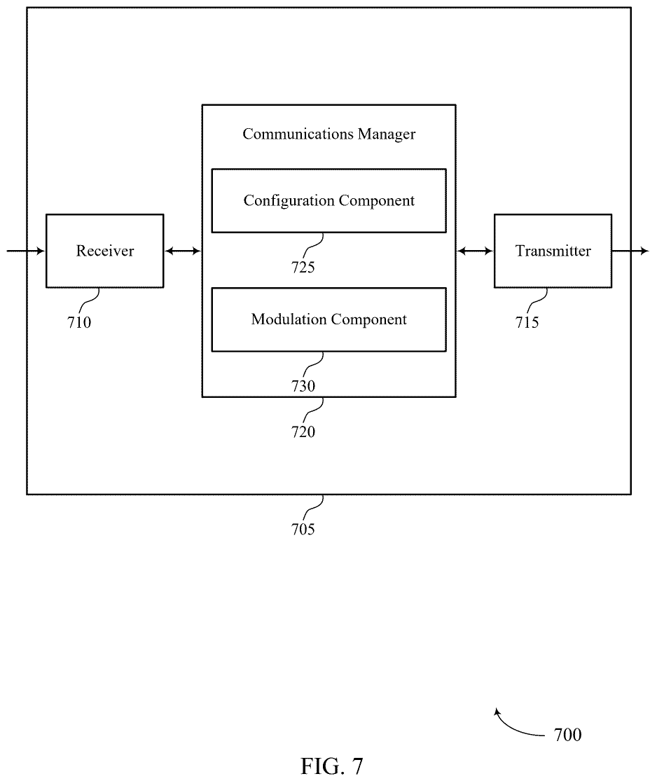

FIG. 7 shows a block diagram 700 of a device 705 that supports techniques for linking modulation for multi-TRP PDCCH in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of techniques for linking modulation for multi-TRP PDCCH as described herein. For example, the communications manager 720 may include a configuration component 725 a modulation component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for outputting a control message indicative of a linkage between a first CORESET and a second CORESET, where the first CORESET is associated with a first TCI state, and where the second CORESET is associated with a second TCI state different from the first TCI state. The modulation component 730 is capable of, configured to, or operable to support a means for outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

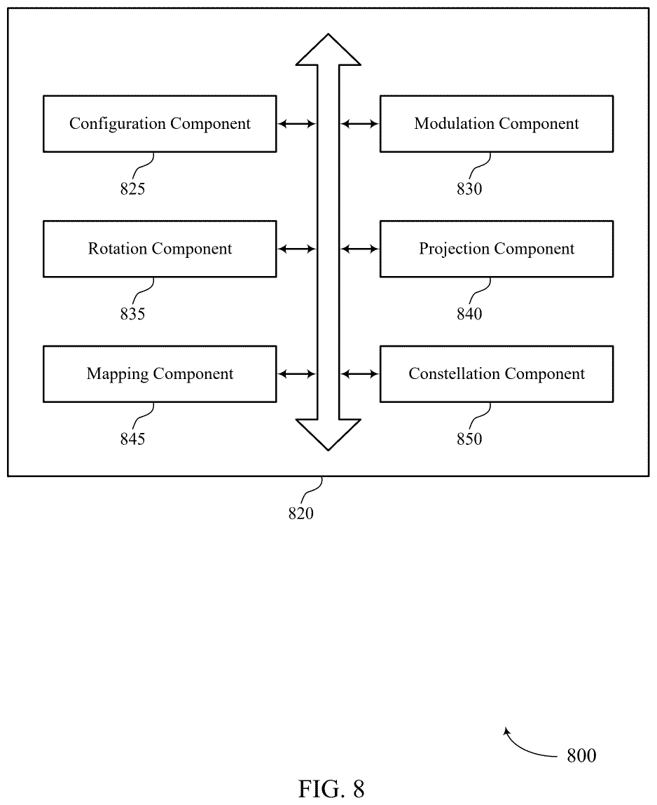

FIG. 8 shows a block diagram 800 of a communications manager 820 that supports techniques for linking modulation for multi-TRP PDCCH in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for linking modulation for multi-TRP PDCCH as described herein. For example, the communications manager 820 may include a configuration component 825, a modulation component 830, a rotation component 835, a projection component 840, a mapping component 845, a constellation component 850, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The configuration component 825 is capable of, configured to, or operable to support a means for outputting a control message indicative of a linkage between a first CORESET and a second CORESET, where the first CORESET is associated with a first TCI state, and where the second CORESET is associated with a second TCI state different from the first TCI state. The modulation component 830 is capable of, configured to, or operable to support a means for outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

In some examples, the rotation component 835 is capable of, configured to, or operable to support a means for rotating a first set of constellation points associated with a first modulation scheme to generate a first set of rotated constellation points. In some examples, the projection component 840 is capable of, configured to, or operable to support a means for projecting the first set of rotated constellation points onto a first axis to generate a first set of projected constellation points and onto a second axis to generate a second set of projected constellation points, where modulation of the first set of symbols is linked to modulation of the second set of symbols based on the projection.

In some examples, the mapping component 845 is capable of, configured to, or operable to support a means for mapping a set of bits associated with the payload to each of the first set of projected constellation points and the second set of projected constellation points, where the first set of symbols is based on the set of bits being mapped to the first set of projected constellation points, and where the second set of symbols is based on the set of bits being mapped to the second set of projected constellation points.

In some examples, each of the first set of projected constellation points and the second set of projected constellation points is associated with a respective one-dimensional constellation.

In some examples, the rotation component 835 is capable of, configured to, or operable to support a means for rotating a second set of constellation points associated with a second modulation scheme to generate a second set of rotated constellation points. In some examples, the projection component 840 is capable of, configured to, or operable to support a means for projecting the second set of rotated constellation points onto a third axis to generate a third set of projected constellation points and onto a fourth axis to generate a fourth set of projected constellation points, where the first set of symbols is based on the first set of projected constellation points and the third set of projected constellation points, and where the second set of symbols is based on the second set of constellation points and the fourth set of projected constellation points.

In some examples, the constellation component 850 is capable of, configured to, or operable to support a means for generating a first two-dimensional constellation based on the first set of projected constellation points and the third set of projected constellation points. In some examples, the constellation component 850 is capable of, configured to, or operable to support a means for generating a second two-dimensional constellation based on the second set of constellation points and the fourth set of projected constellation points. In some examples, the mapping component 845 is capable of, configured to, or operable to support a means for mapping a set of bits associated with the downlink control channel message to each of a third set of constellation points associated with the first two-dimensional constellation and a fourth set of constellation points associated with the second two-dimensional constellation, where the first set of symbols is based on the set of bits being mapped to the third set of constellation points, and where the second set of symbols is based on the set of bits being mapped to the fourth set of projected constellation points.

In some examples, the first set of projected constellation points correspond to respective in-phase components of the third set of constellation points. In some examples, the third set of projected constellation points correspond to respective quadrature-phase components of the third set of constellation points. In some examples, the second set of constellation points correspond to respective in-phase components of the fourth set of constellation points. In some examples, the fourth set of constellation points correspond to respective quadrature-phase components of the fourth set of constellation points.

In some examples, the first set of symbols are equivalent to the second set of symbols based on the projection.

In some examples, the first modulation scheme is a QPSK modulation scheme or a QAM scheme.

In some examples, the first CORESET and the second CORESET are associated with a joint multi-beam SS set. In some examples, the control message is indicative of the joint multi-beam SS set.

In some examples, the downlink control channel message is associated with cross-beam aggregation based on a set of paired CCEs associated with the joint multi-beam SS set. In some examples, each paired control channel element from the set of paired CCEs includes a first CCE from a first set of CCEs associated with the first CORESET and a second CCE from a second set of CCEs associated with the second CORESET.

In some examples, the first RE is output via the first set of CCEs associated with the first CORESET. In some examples, the second RE is output via the second set of CCEs associated with the second CORESET.

In some examples, a cross-beam aggregation level associated with the downlink control channel message is based on a quantity of paired CCEs in the set of paired CCEs.

In some examples, a value corresponding to the cross-beam aggregation level is twice the quantity of the paired CCEs.

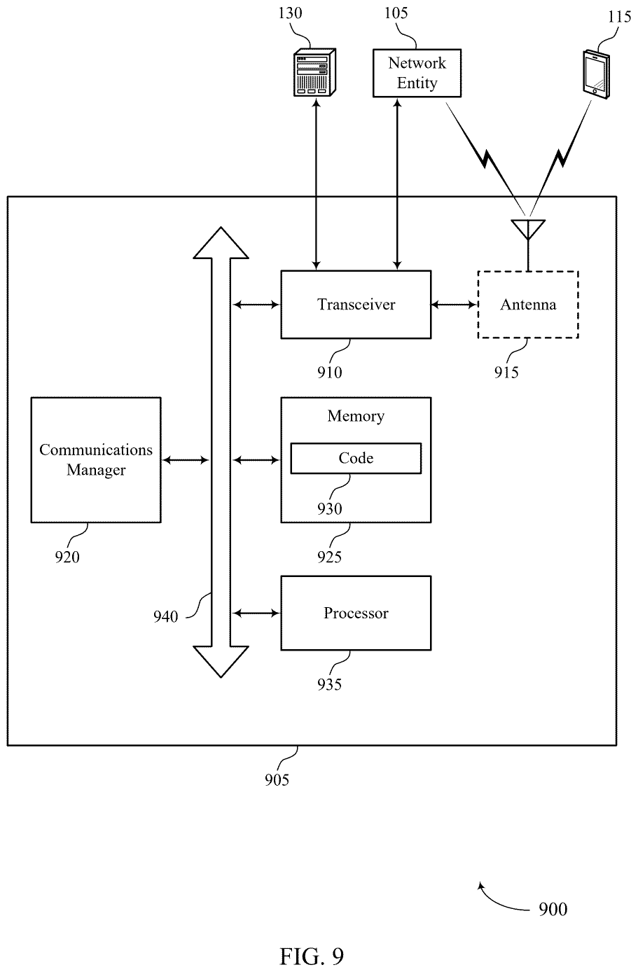

FIG. 9 shows a diagram of a system 900 including a device 905 that supports techniques for linking modulation for multi-TRP PDCCH in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940). The at least one processor 935 may be individually or collectively operable to execute the code 930 (e.g., directly, indirectly, after pre-processing, without pre-processing) to cause the device 905 to perform aspects of the functions described herein.

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting techniques for linking modulation for multi-TRP PDCCH). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for outputting a control message indicative of a linkage between a first CORESET and a second CORESET, where the first CORESET is associated with a first TCI state, and where the second CORESET is associated with a second TCI state different from the first TCI state. The communications manager 920 is capable of, configured to, or operable to support a means for outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based on the linkage between the first CORESET and the second CORESET.

By including or configuring the communications manager 920 in accordance with examples as described herein, the device 905 may support techniques for linking modulation for multi-TRP PDCCH, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of techniques for linking modulation for multi-TRP PDCCH as described herein, or the at least one processor 935 and the at least one memory 925 may be otherwise configured to, individually or collectively, perform or support such operations.

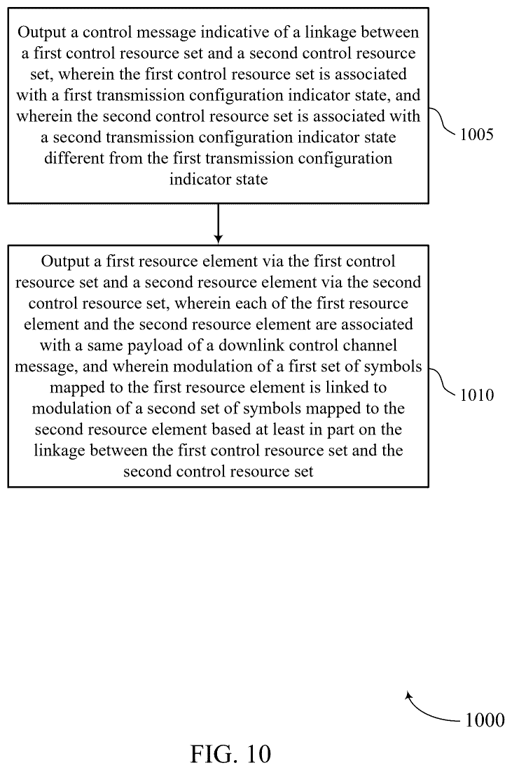

FIG. 10 shows a flowchart illustrating a method 1000 that supports techniques for linking modulation for multi-TRP PDCCH in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include outputting a control message indicative of a linkage between a first CORESET and a second CORESET, where the first CORESET is associated with a first TCI state, and where the second CORESET is associated with a second TCI state different from the first TCI state. The operations of 1005 may be performed in accordance with examples as disclosed herein. In some examples, aspects of the operations of 1005 may be performed by a configuration component 825 as described with reference to FIG. 8.

At 1010, the method may include outputting a first RE via the first CORESET and a second RE via the second CORESET, where each of the first RE and the second RE are associated with a same payload of a downlink control channel message, and where modulation of a first set of symbols mapped to the first RE is linked to modulation of a second set of symbols mapped to the second RE based at least in part on the linkage between the first CORESET and the second CORESET. The operations of 1010 may be performed in accordance with examples as disclosed herein. In some examples, aspects of the operations of 1010 may be performed by a modulation component 830 as described with reference to FIG. 8.

The following provides an overview of aspects of the present disclosure:

Aspect 1: A method for wireless communications at a network entity, comprising: outputting a control message indicative of a linkage between a first CORESET and a second CORESET, wherein the first CORESET is associated with a first TCI state, and wherein the second CORESET is associated with a second TCI state different from the first TCI state; and outputting a first RE via the first CORESET and a second RE via the second CORESET, wherein each of the first RE and the second RE are associated with a same payload of a downlink control channel message, and wherein modulation of a first set of symbols mapped to the first RE is linked to modulation of a second set of symbols mapped to the second RE based at least in part on the linkage between the first CORESET and the second CORESET.

Aspect 2: The method of aspect 1, further comprising: rotating a first set of constellation points associated with a first modulation scheme to generate a first set of rotated constellation points; and projecting the first set of rotated constellation points onto a first axis to generate a first set of projected constellation points and onto a second axis to generate a second set of projected constellation points, wherein modulation of the first set of symbols is linked to modulation of the second set of symbols based at least in part on the projection.

Aspect 3: The method of aspect 2, further comprising: mapping a set of bits associated with the payload to each of the first set of projected constellation points and the second set of projected constellation points, wherein the first set of symbols is based at least in part on the set of bits being mapped to the first set of projected constellation points, and wherein the second set of symbols is based at least in part on the set of bits being mapped to the second set of projected constellation points.

Aspect 4: The method of any of aspects 2 through 3, wherein each of the first set of projected constellation points and the second set of projected constellation points is associated with a respective one-dimensional constellation.

Aspect 5: The method of any of aspects 2 through 4, further comprising: rotating a second set of constellation points associated with a second modulation scheme to generate a second set of rotated constellation points; and projecting the second set of rotated constellation points onto a third axis to generate a third set of projected constellation points and onto a fourth axis to generate a fourth set of projected constellation points, wherein the first set of symbols is based at least in part on the first set of projected constellation points and the third set of projected constellation points, and wherein the second set of symbols is based at least in part on the second set of constellation points and the fourth set of projected constellation points.

Aspect 6: The method of aspect 5, further comprising: generating a first two-dimensional constellation based at least in part on the first set of projected constellation points and the third set of projected constellation points; generating a second two-dimensional constellation based at least in part on the second set of constellation points and the fourth set of projected constellation points; and mapping a set of bits associated with the downlink control channel message to each of a third set of constellation points associated with the first two-dimensional constellation and a fourth set of constellation points associated with the second two-dimensional constellation, wherein the first set of symbols is based at least in part on the set of bits being mapped to the third set of constellation points, and wherein the second set of symbols is based at least in part on the set of bits being mapped to the fourth set of projected constellation points.

Aspect 7: The method of any of aspects 5 through 6, wherein the first set of projected constellation points correspond to respective in-phase components of the third set of constellation points, the third set of projected constellation points correspond to respective quadrature-phase components of the third set of constellation points, the second set of constellation points correspond to respective in-phase components of the fourth set of constellation points, and the fourth set of constellation points correspond to respective quadrature-phase components of the fourth set of constellation points.

Aspect 8: The method of any of aspects 2 through 7, wherein the first set of symbols are equivalent to the second set of symbols based at least in part on the projection.

Aspect 9: The method of any of aspects 2 through 8, wherein the first modulation scheme is a quadrature phase shift keying (QPSK) modulation scheme or a quadrature amplitude modulation (QAM).

Aspect 10: The method of any of aspects 1 through 9, wherein the first CORESET and the second CORESET are associated with a joint multi-beam search space set, and the control message is indicative of the joint multi-beam search space set.

Aspect 11: The method of aspect 10, wherein the downlink control channel message is associated with cross-beam aggregation based at least in part on a set of paired control channel elements associated with the joint multi-beam search space set, and each paired control element from the set of paired control channel elements includes a first control channel element from a first set of control channel elements associated with the first CORESET and a second control channel element from a second set of control channel elements associated with the second CORESET.

Aspect 12: The method of aspect 11, wherein the first RE is output via the first set of control channel elements associated with the first CORESET, and the second RE is output via the second set of control channel elements associated with the second CORESET.

Aspect 13: The method of any of aspects 11 through 12, wherein a cross-beam aggregation level associated with the downlink control channel message is based at least in part on a quantity of paired control channel elements in the set of paired control channel elements.

Aspect 14: The method of aspect 13, wherein a value corresponding to the cross-beam aggregation level is twice the quantity of the paired control channel elements.

Aspect 15: A network entity for wireless communications, comprising one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the network entity to perform a method of any of aspects 1 through 14.

Aspect 16: A network entity for wireless communications, comprising at least one means for performing a method of any of aspects 1 through 14.

Aspect 17: A non-transitory computer-readable medium storing code for wireless communications at a network entity, the code comprising instructions executable by at least one processor (e.g., directly, indirectly, after pre-processing, without pre-processing) to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or both. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
output a control message indicative of a linkage between a first control resource set and a second control resource set, wherein the first control resource set is associated with a first transmission configuration indicator state, and wherein the second control resource set is associated with a second transmission configuration indicator state different from the first transmission configuration indicator state; and
output a first resource element via the first control resource set and a second resource element via the second control resource set, wherein each of the first resource element and the second resource element are associated with a same payload of a downlink control channel message, and wherein modulation of a first set of symbols mapped to the first resource element is linked to modulation of a second set of symbols mapped to the second resource element based at least in part on the linkage between the first control resource set and the second control resource set.

2. The network entity of claim 1, wherein the one or more processors are individually or collectively further operable to execute the code to cause the network entity to:
rotate a first set of constellation points associated with a first modulation scheme to generate a first set of rotated constellation points; and
project the first set of rotated constellation points onto a first axis to generate a first set of projected constellation points and onto a second axis to generate a second set of projected constellation points, wherein modulation of the first set of symbols is linked to modulation of the second set of symbols based at least in part on the projection.

3. The network entity of claim 2, wherein the one or more processors are individually or collectively further operable to execute the code to cause the network entity to:
map a set of bits associated with the payload to each of the first set of projected constellation points and the second set of projected constellation points, wherein the first set of symbols is based at least in part on the set of bits being mapped to the first set of projected constellation points, and wherein the second set of symbols is based at least in part on the set of bits being mapped to the second set of projected constellation points.

4. The network entity of claim 2, wherein each of the first set of projected constellation points and the second set of projected constellation points is associated with a respective one-dimensional constellation.

5. The network entity of claim 2, wherein the one or more processors are individually or collectively further operable to execute the code to cause the network entity to:
rotate a second set of constellation points associated with a second modulation scheme to generate a second set of rotated constellation points; and
project the second set of rotated constellation points onto a third axis to generate a third set of projected constellation points and onto a fourth axis to generate a fourth set of projected constellation points, wherein the first set of symbols is based at least in part on the first set of projected constellation points and the third set of projected constellation points, and wherein the second set of symbols is based at least in part on the second set of constellation points and the fourth set of projected constellation points.

6. The network entity of claim 5, wherein the one or more processors are individually or collectively further operable to execute the code to cause the network entity to:
generate a first two-dimensional constellation based at least in part on the first set of projected constellation points and the third set of projected constellation points;
generate a second two-dimensional constellation based at least in part on the second set of constellation points and the fourth set of projected constellation points; and
map a set of bits associated with the downlink control channel message to each of a third set of constellation points associated with the first two-dimensional constellation and a fourth set of constellation points associated with the second two-dimensional constellation, wherein the first set of symbols is based at least in part on the set of bits being mapped to the third set of constellation points, and wherein the second set of symbols is based at least in part on the set of bits being mapped to the fourth set of projected constellation points.

7. The network entity of claim 6, wherein the first set of projected constellation points correspond to respective in-phase components of the third set of constellation points, wherein the third set of projected constellation points correspond to respective quadrature-phase components of the third set of constellation points, wherein the second set of constellation points correspond to respective in-phase components of the fourth set of constellation points, and wherein the fourth set of constellation points correspond to respective quadrature-phase components of the fourth set of constellation points.

8. The network entity of claim 2, wherein the first set of symbols are equivalent to the second set of symbols based at least in part on the projection.

9. The network entity of claim 2, wherein the first modulation scheme is a quadrature phase shift keying (QPSK) modulation scheme or a quadrature amplitude modulation (QAM) scheme.

10. The network entity of claim 1, wherein the first control resource set and the second control resource set are associated with a joint multi-beam search space set, and wherein the control message is indicative of the joint multi-beam search space set.

11. The network entity of claim 10, wherein the downlink control channel message is associated with cross-beam aggregation based at least in part on a set of paired control channel elements associated with the joint multi-beam search space set, and wherein each paired control channel element from the set of paired control channel elements includes a first control channel element from a first set of control channel elements associated with the first control resource set and a second control channel element from a second set of control channel elements associated with the second control resource set.

12. The network entity of claim 11, wherein the first resource element is output via the first set of control channel elements associated with the first control resource set, and wherein the second resource element is output via the second set of control channel elements associated with the second control resource set.

13. The network entity of claim 11, wherein a cross-beam aggregation level associated with the downlink control channel message is based at least in part on a quantity of paired control channel elements in the set of paired control channel elements.

14. The network entity of claim 13, wherein a value corresponding to the cross-beam aggregation level is twice the quantity of the paired control channel elements.

15. A method for wireless communications at a network entity, comprising:
outputting a control message indicative of a linkage between a first control resource set and a second control resource set, wherein the first control resource set is associated with a first transmission configuration indicator state, and wherein the second control resource set is associated with a second transmission configuration indicator state different from the first transmission configuration indicator state; and
outputting a first resource element via the first control resource set and a second resource element via the second control resource set, wherein each of the first resource element and the second resource element are associated with a same payload of a downlink control channel message, and wherein modulation of a first set of symbols mapped to the first resource element is linked to modulation of a second set of symbols mapped to the second resource element based at least in part on the linkage between the first control resource set and the second control resource set.

16. The method of claim 15, further comprising:
rotating a first set of constellation points associated with a first modulation scheme to generate a first set of rotated constellation points; and
projecting the first set of rotated constellation points onto a first axis to generate a first set of projected constellation points and onto a second axis to generate a second set of projected constellation points, wherein modulation of the first set of symbols is linked to modulation of the second set of symbols based at least in part on the projection.

17. The method of claim 16, further comprising:
mapping a set of bits associated with the payload to each of the first set of projected constellation points and the second set of projected constellation points, wherein the first set of symbols is based at least in part on the set of bits being mapped to the first set of projected constellation points, and wherein the second set of symbols is based at least in part on the set of bits being mapped to the second set of projected constellation points.

18. The method of claim 16, further comprising:
rotating a second set of constellation points associated with a second modulation scheme to generate a second set of rotated constellation points; and
projecting the second set of rotated constellation points onto a third axis to generate a third set of projected constellation points and onto a fourth axis to generate a fourth set of projected constellation points, wherein the first set of symbols is based at least in part on the first set of projected constellation points and the third set of projected constellation points, and wherein the second set of symbols is based at least in part on the second set of constellation points and the fourth set of projected constellation points.

19. A network entity for wireless communications, comprising:
means for outputting a control message indicative of a linkage between a first control resource set and a second control resource set, wherein the first control resource set is associated with a first transmission configuration indicator state, and wherein the second control resource set is associated with a second transmission configuration indicator state different from the first transmission configuration indicator state; and
means for outputting a first resource element via the first control resource set and a second resource element via the second control resource set, wherein each of the first resource element and the second resource element are associated with a same payload of a downlink control channel message, and wherein modulation of a first set of symbols mapped to the first resource element is linked to modulation of a second set of symbols mapped to the second resource element based at least in part on the linkage between the first control resource set and the second control resource set.

20. The network entity of claim 19, further comprising:
means for rotating a first set of constellation points associated with a first modulation scheme to generate a first set of rotated constellation points; and
means for projecting the first set of rotated constellation points onto a first axis to generate a first set of projected constellation points and onto a second axis to generate a second set of projected constellation points, wherein modulation of the first set of symbols is linked to modulation of the second set of symbols based at least in part on the projection.
